(19) United States
(12) Patent Application Publication
(10) Pub. No.: US 2003/0089010 A1
(43) Pub. Date: May 15, 2003

(54) Portable message board

(75) Inventors: Mitchell Wechter, Monroe, CT (US); Maggie Walsh, Marstons Mills, MA (US); Murry Boardman, Boynton Beach, FL (US)

Correspondence Address: Finnegan, Henderson, Farabow,, Garrett & Dunner, L.L.P., 1300 I Street, N.W., Washington, DC, 20005-3315, US

(73) Assignee: J.M. Wechter & Associates

(21) Appl. No.: 09/986,796

(22) Filed: Nov. 13, 2001

(51) Int. Cl. G09F 7/00

(52) U.S. Cl. 40/584

(57) ABSTRACT

A portable message board that, in a preferred embodiment, includes an audio entertainment device (radio or CD player) and an advertisement area so as to provide a promotional gift that advertisers can use to promote their brands. The message board has a housing with a front face and side edges defining a cavity. The side edges may be integral with the front face of the housing, or it may be a separate frame. The audio device is provided in the cavity. The front face has a message area which preferably includes an erasable board and optionally one or more of a magnetic board, a chalkboard, a pad of paper, or a corkboard for receiving a message. The message board has a fastener that allows it to be removably attached to a surface.

### FIELD OF THE INVENTION

The present invention relates to portable message boards.

### BACKGROUND OF THE INVENTION

Currently there are various types of message boards in use. Conventional message boards provide either a pin-penetrable material (e.g. cork) on which to tack paper messages or an erasable (e.g. dry-erase) board that allows users to write on the board and erase the messages with ease. Some boards have accessories such as pen or marker holders and shelves to place items on. Another type of message board has a pad of paper on which to write messages. Once the message is read, the reader may tear off the page with the message thereby exposing a blank page beneath on which a new message may be written.

Companies seeking new promotional opportunities have sought to give away practical, inexpensive, and novel devices that would promote their brands while providing consumers with an item they will use and refer to when considering what company to patronize. Yet prior art message boards have become uninteresting and commonplace, thereby making it less attractive for companies to use them as promotional gifts. In light of the foregoing, there is a need for a portable message board that operates as effectively as previous boards, but which also comprises a more desirable item for consumers and/or a new and creative way of promoting a brand name.

### SUMMARY OF THE INVENTION

The present invention is a portable message board incorporating additional features that enhance its appeal to end-users and/or promoters. Some of the additional features incorporated into the message board are an electronic audio entertainment device, such as a radio or compact disc player, with readily accessible user controls. An advertisement area may be provided on the front face of the board. The board can be attached to a refrigerator door or the like in a home or office. Because of the inclusion of novel features and a potential for low-cost manufacture, end users will seek out and use these boards and companies will desire to place their logos on them and give them away as promotional gifts.

In one embodiment, the message board comprises a housing having a front face and side edges defining a cavity. A message area is located on the front face. An integrated audio device such as a radio is located in the cavity and has user controls accessible from the exterior of the housing, e.g., a power switch, a frequency tuner, and a volume control. The message board also has a fastener for removably mounting the housing to a surface.

In one preferred embodiment, the front face and side edges comprise an integral piece of molded plastic. The plastic front face can be used as a dry erase board, thus providing a low-cost construction. The user controls, to the radio or the like, may be accessible through apertures in the molded piece, either in the front face or side edges (e.g., preferably the right side edge for right handed-users).

In one embodiment, the front face has a speaker opening, such as an area of several small perforations. In other embodiments, the speaker opening may be on a rear face or on the side edges.

In various embodiments, one or more additional mediums through which a user may leave a message are provided which further enhance the utility and desirability of the message board. For example, the message board may include one or more of an erasable board, a chalkboard, a cork board, a pad of paper, and a magnetic board.

In one embodiment, a frame is provided which forms the side edges or is positioned over or adjacent the side edges. The frame may be made of various materials such as plastic, wood, metal, or a composite material.

In other embodiments, the message board includes a writing utensil and/or a writing utensil holder. The writing utensil may be of any type and will vary depending on the message area's writing surface. Where the message area is an erasable board, such as a whiteboard, the writing utensil may be a dry erase marker. The writing utensil and/or holder can be either attached to the message board itself or be separate from the message board, but used in conjunction with it. The writing utensil may be removably attached to the holder such that when not in use, the utensil rests in its holder.

In one embodiment, the message board has a fastener, for removably mounting the board to a wall or other surface, comprising one or more magnets attached to a rear face of the housing. The magnets allow the message board to be mounted to the door of a refrigerator or other metallic surface. The fastener may also be a “stick-on” fastener, Velcro, suction cup, clip, opening, hook, tape, or adhesive that allows the message board to removably attach to a surface.

In a preferred embodiment of the invention, the front face includes an advertisement area. Thus, a company seeking to promote its name, brand, message, product or the like, would place its advertisement on the front face so that when an end user positions the message board on a surface (e.g., a refrigerator door), each time the board is encountered the advertiser's message will be viewed.

In another embodiment, the message board includes a compact disc player as the audio device. The compact disc player is located in the housing cavity. The compact disc player may include at least one speaker, a power switch, a volume control, a disc receiving cartridge, and play controls, all of which are preferably accessible from the exterior of the housing, preferably through either the front face or side edges.

It is to be understood that the foregoing general description and the following detailed description are exemplary and explanatory only and are not restrictive of the invention, as claimed.

The accompanying drawings illustrate several embodiments of the invention and together with the description, serve to explain the principles of the invention.

### BRIEF DESCRIPTION OF THE DRAWINGS

FIG. 1 is an exploded front isometric view of an erasable message board according to one embodiment of the present invention, showing an interior cavity formed between a front face portion and a rear face portion with overlapping side edges.

FIG. 2 is an exploded isometric view of a second embodiment, further including a separate frame member and additional type of message area on the front face.

FIG. 3 is a side plan view of the message board of FIG. 1, attached to a wall surface (shown in phantom lines).

FIG. 4 is an isometric front view of an assembled message board of the type shown in FIG. 1, but without an advertisement on the front face and without a writing utensil and holder.

FIG. 5 is a front plan view of the message board of FIG. 4.

FIG. 6 is a top plan view of the message board of FIG. 4.

FIG. 7 is a left side plan view of the message board of FIG. 4.

FIG. 7 is a right side plan view of the message board of FIG. 4.

FIG. 9 is a rear plan view of the message board of FIG. 4.

### DESCRIPTION OF THE EMBODIMENTS

Reference will now be made to select embodiments which are illustrated in the accompanying drawings. Wherever possible, the same reference numbers are used throughout the drawings to refer to the same or like parts.

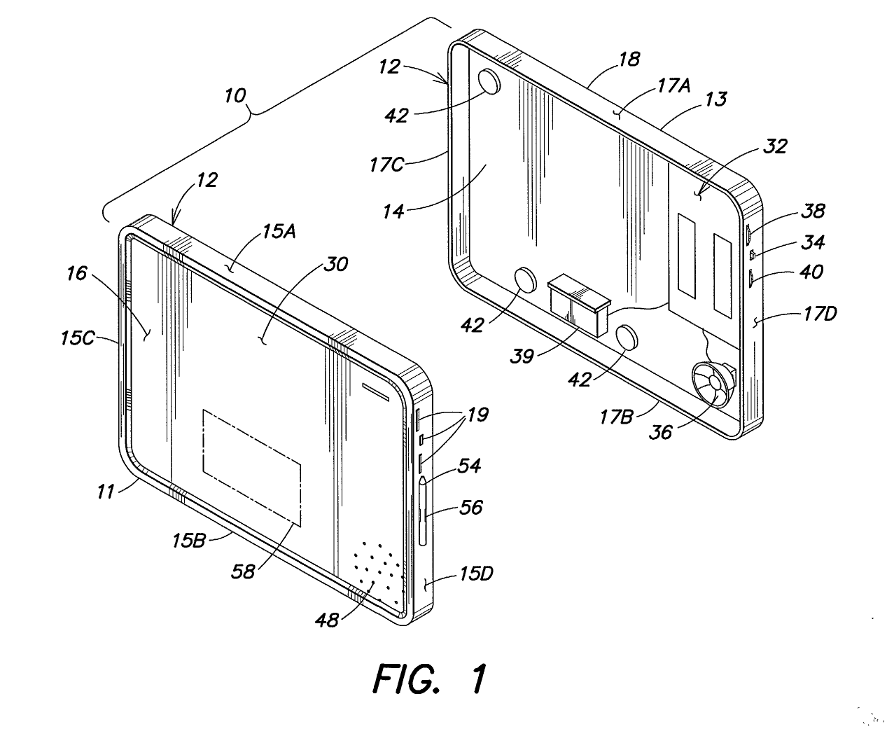

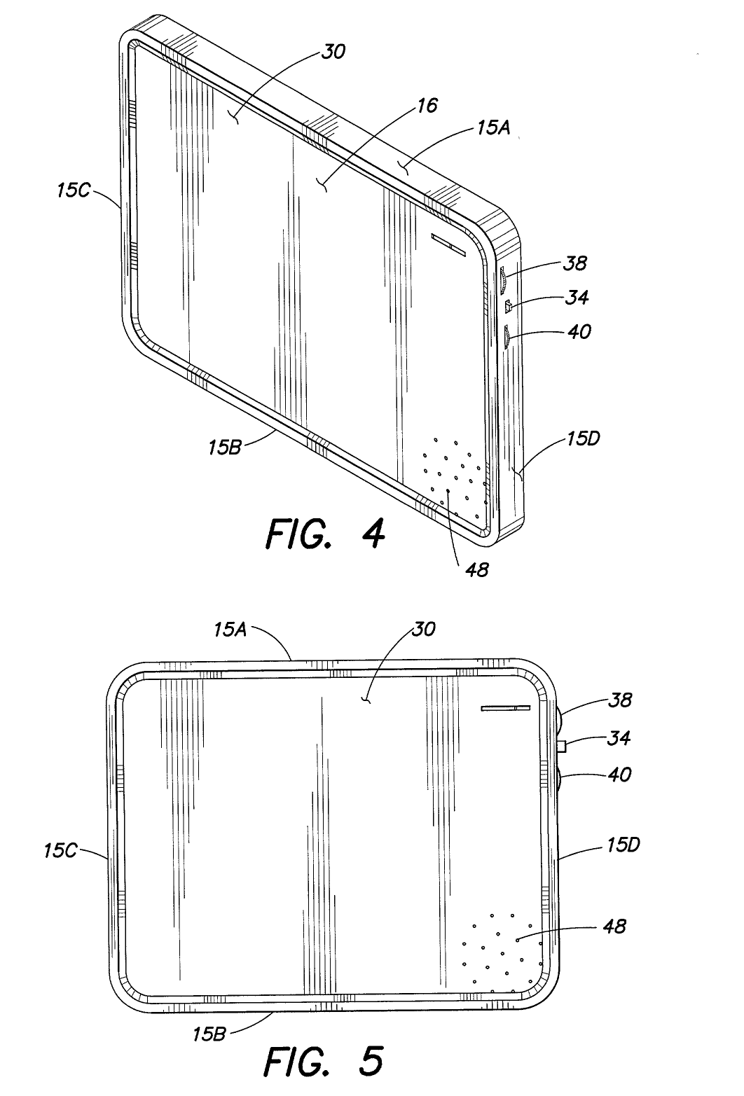

One embodiment of the message board of the present invention is shown in FIG. 1 and is designated generally by reference numeral 10. Message board 10 includes a housing 12 formed by a molded plastic front portion 11 having a front face 16 and four connecting side edges (top 15A, bottom 15B, left 15C, right 15D) and a molded plastic rear portion 13 having a rear face 18 and again four connecting side edges (top 17A, bottom 17B, left 17C, right 17D). The side edges 15A-15D overlap respective side edges 17A-17D in the assembled board (see FIG. 4) and form an interior cavity 14 between the front and rear faces 16, 18.

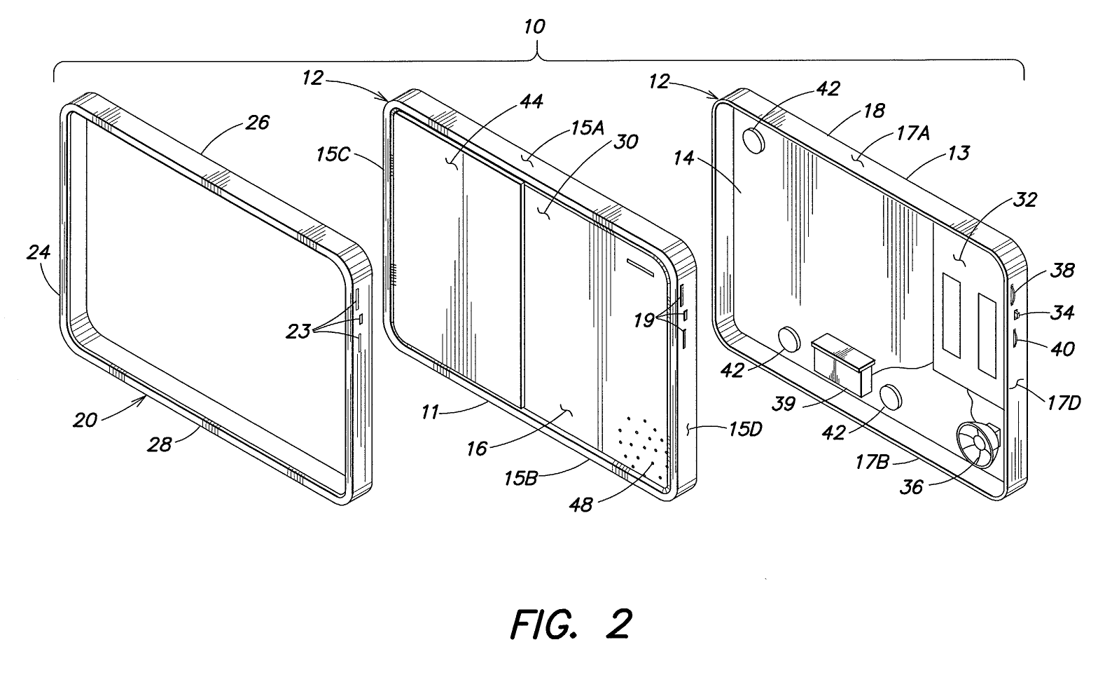

FIG. 2 shows another embodiment in which a separate frame 20 is provided, in addition to the front and rear portions, the frame 20 being mountable over the overlapping side edges 15A-D and 17A-D. More specifically, frame 20 has side edges including parallel top and bottom edges 26 and 28 and orthogonal thereto left-hand and right-hand side edges 24 and 22 forming a parallelogram. In this embodiment, frame 20 is rectangular and is made of a plastic material. Frame 20, however, may be constructed of any known material such as wood, metal, or a composite. Here frame 20 is not required because the front and/or rear portions 11, 13 include side edges for connecting the faces to form a housing with an interior cavity. In this example frame 20 provides a decorative effort, and/or strengthens the overall construction. In other embodiments, where the front and rear portions may have no side edges, a separate frame may be required to form the sides of the housing.

In each of FIGS. 1 and 2, the front face 16 of the molded plastic front portion 11 forms a dry erase whiteboard for use as a message area 30. In FIG. 2, a cork board 44, covering the left side of the front face, provides an additional portion of the message area 30.

Also in each of FIGS. 1 and 2, an audio entertainment device 32 is provided for listening to music; device 32 does not allow audio recording. Here device 32 is a radio, powered by batteries located in a battery compartment 39. The radio has a power switch 34, a speaker 36, a frequency tuner 38, and a volume control 40. The power switch 34, frequency tuner 38 and volume control 40 comprise user controls which are each accessible from the exterior of housing 12 because they extend through overlapping apertures 19 and 21 in each of the overlapping right side edges 15D and 17D of the front and rear housing portions (and in FIG. 2 through apertures 23 in the frame's right side edge 22).

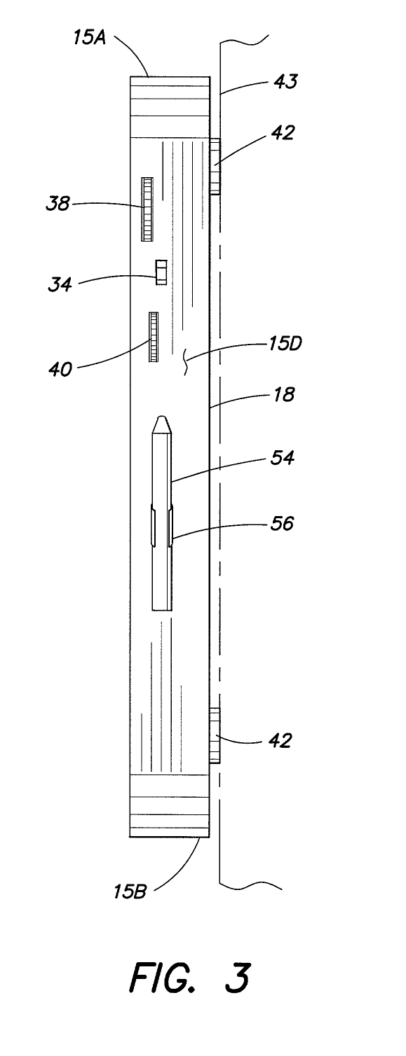

In each of FIGS. 1 and 2, a rear face 18 of the message board housing includes multiple magnets 42 for mounting housing 12 to a surface 43 (shown in phantom lines in FIG. 3). Other fasteners may be used as previously described.

Front face 16 also has a speaker opening 48 that may be in the form of several small perforations through which the audio output of speaker 36 may be heard. In other embodiments, an opening for the speaker may be on the rear face or side edges.

In the first embodiment of FIGS. 1 and 3, message board 10 includes a writing utensil 54 and a writing utensil holder 56. In this embodiment where message area 30 is a whiteboard, the writing utensil 54 is a dry-erase marker. Holder 56 is mounted on the right side edge 15D of housing 12, for ease of use (by right-handed users). The marker 56 is removably attached to the holder 54 such that, when not in use, marker 56 rests in holder 54, but when needed it may be removed from holder 54.

Also shown in FIG. 1 is an area 58 for an advertisement on front face 16. Thus, a company seeking to promote its name, brand, logo, product, message, or the like may place the same on area 58 so that when an end user attaches message board 10 to a surface, such as a refrigerator door, the name (or other advertisement) will be prominently displayed. The advertisement may include additional information about the company, such as an address and/or phone number.

FIG. 4 is a schematic view of an assembled housing of the type shown in FIG. 1, but without advertisement area 58 and without writing utensil and holder 56 and 54.

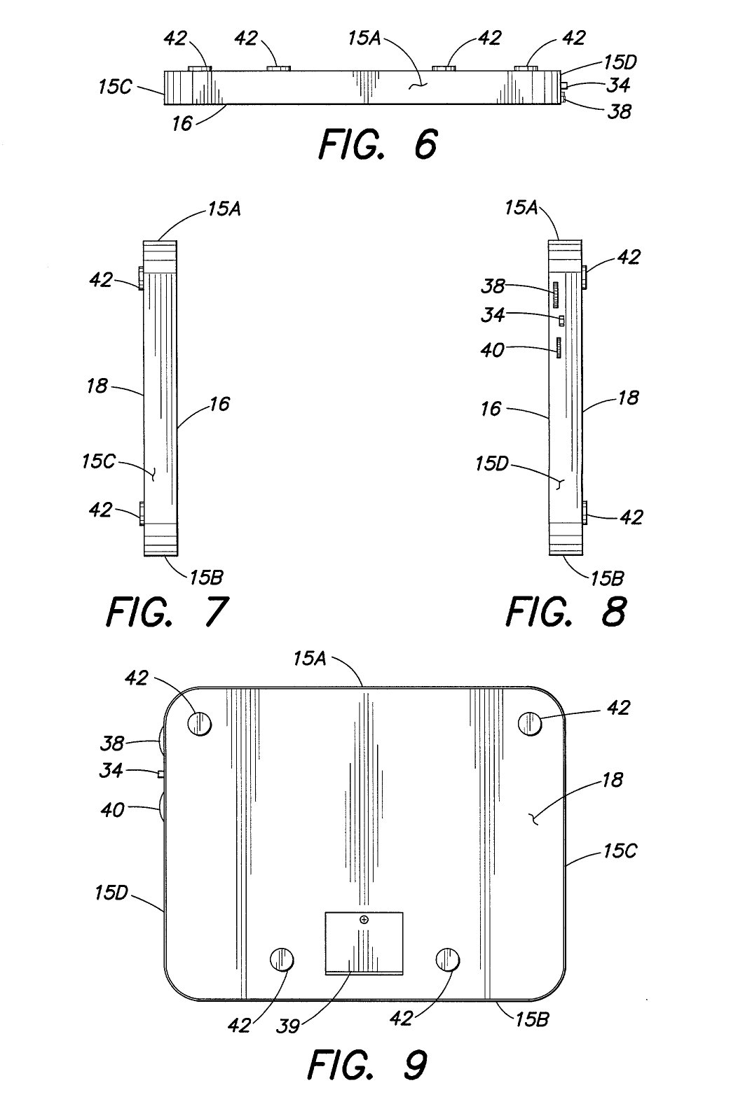

FIGS. 5-9 are respectively front, top, left-side, right-side and rear views of the housing of FIG. 4. FIG. 9 shows the rear door of the battery compartment 39, which is accessible to the user.

Other embodiments of the invention will be apparent to those skilled in the art from consideration of the specification and practice of the invention disclosed herein. It is intended that the specification and examples be considered as exemplary only, with the scope of the invention being designated by the following claims.

1. A portable message board comprising:
a housing having a front face and side edges defining a cavity;
a message area located on the front face;
an audio located in the cavity, the audio device having user controls accessible from the exterior of the housing; and
a fastener for removably mounting the housing to a surface.

2. The message board of claim 1 wherein the message area comprises at least one of an erasable board, a blackboard, a pad of paper, a magnetic board, and a material for attaching messages, or any combination thereof.

3. The message board of claim 1 wherein the front face comprises an erasable board as the message area.

4. The message board of claim 1 further including an advertisement area on the front face.

5. The message board of claim 1 wherein the audio device comprises a radio or a CD player.

6. The message board of claim 1 wherein the user controls are accessible through at least one aperture in the side edges.

7. The message board of claim 6 wherein the at least one aperture is located on the right side edge.

8. The message board of claim 1 wherein the front face has at least one speaker opening.

9. The message board of claim 1 further comprising a frame made of plastic, wood, metal, a composite material, or any combination thereof.

10. The message board of claim 1 further comprising at least one of a writing utensil and a writing utensil holder.

11. The message board of claim 1 wherein a writing utensil holder is located on the housing.

12. The message board of claim 1 wherein the fastener is located on a rear face of the housing.

13. The message board of claim 12 wherein the fastener comprises at least one magnet attached to the rear face.

14. A portable message board comprising:
a housing comprising an integral piece of molded plastic having a front face and side edges and defining a cavity;
the plastic front face serving as a write-on message area;
an electronic audio entertainment device located in the cavity, the audio device having user controls accessible from the exterior of the housing through either the front face or the side edges; and
a fastener for removably mounting the housing to a surface.

15. The message board of claim 14 further including an advertisement area on the front face.

16. The message board of claim 15 wherein the entertainment device is a radio.

17. The message board of claim 15 wherein the entertainment device is a CD player.

18. The message board of claim 15 wherein the front face has a speaker opening.

19. The message board of claim 15 wherein the housing includes a rear face.

20. The message board of claim 15 further including a writing utensil holder located on the housing.
